(19) United States
(12) Patent Application Publication
(10) Pub. No.: US 2008/0031316 A1
(43) Pub. Date: Feb. 7, 2008

(54) Carrier Recovery Architecture With Improved Acquisition

(76) Inventors: Belotserkovsky B. Maxim, Carmel, IN (US); Dong-Chang Shiue, Carmel, IN (US)

Correspondence Address: THOMSON LICENSING LLC, Two Independence Way, Suite 200, PRINCETON, NJ, 08540, US

(21) Appl. No.: 11/579,848

(22) PCT Filed: Feb. 2, 2005
(86) PCT No.: PCT/US05/02867

§ 371 Date: Nov. 8, 2006

Related U.S. Application Data
(60) Provisional application No. 60/570,294, filed on May 12, 2004.

(51) Int. Cl. H04L 27/01

(52) U.S. Cl. 375/232

(57) ABSTRACT

A carrier recovery and equalization architecture for use with a digital communication system receiver can include a carrier tracking loop having an equalizer. The equalizer can be selectively positionable to a location that is external to the carrier tracking loop (FIG. 3) and to a location within the carrier tracking loop (FIG. 2). The equalizer can be positioned according to a measure of convergence for the carrier tracking loop

### BACKGROUND OF THE INVENTION

The present invention generally relates to digital communication systems and, more particularly, to an architecture for carrier recovery and equalization for use with communication system receivers.

The recovery of data from modulated signals conveying digital information in symbol form usually requires three functions at a receiver: timing recovery for symbol synchronization, carrier recovery (frequency demodulation to baseband), and channel equalization. Timing recovery is a process by which a receiver clock (timebase) is synchronized to a transmitter clock. This permits a received signal to be sampled at optimum points in time to reduce slicing errors associated with decision-directed processing of received symbol values. Carrier recovery is a process by which a received radio frequency (RF) signal, after being frequency down converted to a lower intermediate frequency (IF) passband (e.g., near baseband), is frequency shifted to baseband to permit recovery of the modulating baseband information. Adaptive channel equalization is a process of compensating for the effects of changing conditions and disturbances in the signal transmission channel. This process typically employs filters that remove amplitude and phase distortions resulting from frequency dependent time variant characteristics of the transmission channel.

Many digital data communication systems employ adaptive equalization to compensate for the effects of changing channel conditions and disturbances on the signal transmission channel. Equalization removes baseband intersymbol interference (ISI) caused by transmission channel disturbances including the low pass filtering effect of the transmission channel. ISI causes the value of a given symbol to be distorted by the values of preceding and following symbols, and essentially represents symbol “ghosts”.

An adaptive equalizer is essentially an adaptive filter. In systems using an adaptive equalizer, it is necessary to provide a method of adapting the filter response so as to adequately compensate for channel distortions. Several algorithms are available for adapting the filter coefficients, thereby changing the filter response. One widely used method employs the Least Mean Squares (LMS) algorithm, which varies filter coefficient values as a function of an error signal. The error signal is formed by subtracting the equalizer output signal from a reference data sequence. As the error signal approaches zero, the equalizer approaches convergence.

When the equalizer operation is initiated, the filter coefficient values (filter tap weights) are usually not set at values which produce adequate compensation of channel distortions. In order to force initial convergence of the filter coefficients, a known “training” signal may be used as the reference signal. The training signal is transmitted to the receiver. The error signal is formed at the receiver by subtracting a locally generated copy of the training signal from the output of the adaptive equalizer, which represents the received training signal. The use of a known signal helps to open the initially occluded “eye”, as known in the art.

After adaptation with the training signal, the “eye” has opened considerably and the equalizer is switched to a decision-directed operating mode for receiving symbols representing data. In this mode, final convergence of the filter tap weights is achieved by using the actual values of data symbols from the output of the equalizer for adapting the filter coefficients instead of using the training signal. The decision directed equalizing mode is capable of tracking and canceling time varying channel distortions more rapidly than methods using training signals. In order for decision directed equalization to provide reliable convergence and stable coefficient values, approximately 90% of the decisions must be correct. The use of a training signal to initially adapt the filter coefficients helps the equalizer achieve this 90% correct decision level.

In practice, however, a training signal is not always available. In such cases “blind’ equalization is often used to provide initial convergence of the equalizer coefficient values and to force the eye to open. Blind equalization has been extensively studied and used for quadrature amplitude modulation (QAM) systems, for example. Among the most popular blind equalization algorithms are the Constant Modulus Algorithm (CMA) and the Reduced Constellation Algorithm (RCA). These algorithms are discussed, for example, in Proakis, Digital Communications, McGraw-Hill: New York, 1989 and in Godard, Self-Recovering Equalization and Carrier Tracking in Two Dimensional Data Communication Systems,” IEEE Transactions on Communications, November 1980.

Briefly, the CMA relies on the fact that, at the decision instants, the modulus of the detected data symbols should lie on a locus of points defining one of several (constellation) circles of different diameters. The RCA relies on forming “super constellations” within the main transmitted constellation. The data signal is first forced to fit into a super constellation. Then the super constellation is subdivided to include the entire constellation.

Typically, within digital communication system receivers, equalization and carrier recovery are entangled within a single loop. Both are included within the same loop because, for optimal reception, an equalizer must have at its input a constellation that is not spinning after the residual carrier frequency offset has been removed. This is particularly true with respect to decision-directed equalization. The carrier error detector, which also is commonly decision-directed, functions more efficiently and accurately with an equalized signal.

However, this architecture has an inherent shortcoming resulting from the excessive multi-symbol delay that is introduced into the carrier tracking loop (CTL) by the equalizer's feed-forward (Non-Causal) section. This excessive delay is known to limit the maximum allowable loop gain as well as to limit the carrier acquisition range. One common solution has been to keep the loop gain sufficiently low thereby ensuring stability. This approach also circumvents the limited acquisition range by “stepping” through the desired acquisition range while allowing sufficient time for the CTL to acquire at each step.

It would be beneficial to reduce the multi-symbol delay that is introduced into the CTL by the equalizer while also preserving the advantages associated with the inclusion of an equalizer within a CTL.

### SUMMARY OF THE INVENTION

A method and system for carrier recovery and equalization for use within a receiver is provided. In accordance with the principles of the invention, a receiver comprises a carrier tracking loop (CTL) and an equalizer that is selectively configured either external to the CTL or within the CTL. Illustratively, the equalizer can be positioned according to a measure of convergence for the CTL. The measure of convergence can be met when the CTL converges to about a true residual offset value. Notably, the equalizer can operate in a blind mode when located external to the CTL and can be switched to a decision-directed mode when within the CTL.

In one embodiment, the CTL comprises a derotator configured to derotate receive symbols and a slicer configured to correct errors in the received symbols. The CTL also includes an error detector configured to compare symbol output of the slicer with the received symbols to determine an error signal, a loop filter for processing the error signal, and a numerically controlled oscillator. The numerically controlled oscillator can be driven by an output from the loop filter to provide a signal to the derotator for use in derotating the received symbols.

When located external to the CTL, the equalizer is illustratively located prior to the derotator with respect to the signal path. When located within the CTL, the equalizer is illustratively located between the derorator and the slicer. The equalizer can adapt to the incoming symbols and responsively suspend adaptation.

### BRIEF DESCRIPTION OF THE DRAWINGS

Preferred embodiments of the present invention will be described below in more detail, with reference to the accompanying drawings.

FIG. 1 shows an illustrative block diagram of a receiver in accordance with the principles of the invention;

FIG. 2 shows an illustrative block diagram illustrating a carrier tracking loop (CTL) having a variable architecture in accordance with one aspect of the present invention;

FIG. 3 shows an illustrative block diagram illustrating a CTL having a variable architecture in accordance with another aspect of the present invention;

FIG. 4 shows another illustrative block diagram of a CTL in accordance with the principles of the invention;

FIG. 5 is an illustrative flow chart illustrating a method of performing carrier recovery and equalization using a CTL architecture having a selectively locatable equalizer; and

FIG. 6 is another illustrative flow chart in accordance with the principles of the invention.

### DETAILED DESCRIPTION

Other than the inventive concept, the elements shown in the figures are well known and will not be described in detail. For example, other than the inventive concept, a set-top box or digital television (DTV) and the components thereof, such as a front-end, Hilbert filter, carrier tracking loop, video processor, remote control, etc., are well known and not described in detail herein. In addition, the inventive concept may be implemented using conventional programming techniques, which, as such, will not be described herein. Finally, like-numbers on the figures represent similar elements.

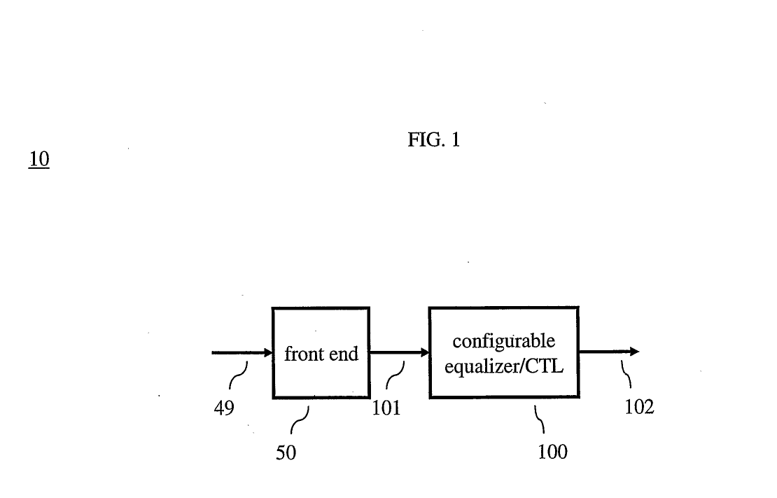

The present invention provides a carrier tracking loop (CTL) configuration having a variable architecture. This is illustrated in FIG. 1. for a receiver 10. The latter comprises a front end section 50 and a configurable equalizer/CTL 100. Front end section 50 processes a received signal 49 to provide a near base band signal 101 to configurable equalizer/CTL 100, which further processes near base band signal 101 to provide a demodulated signal 102 for processing by other elements (not shown) of receiver 10. In accordance with the inventive arrangements disclosed herein, the architecture of equalizer/CTL 100 is dynamic and can be changed to allow for faster acquisition and/or a wider carrier acquisition range. The equalizer/CTL 100 architecture can be switched for different operation modes based on signals coming from equalizer CTL lock detectors. Different loop architectures are used depending on the mode of operation of the equalizer. The inventive arrangements disclosed herein provide enhanced operation of a receiver without an appreciable increase in hardware complexity. For simplicity in the description that follows, equalizer/CTL 100 will be referred to as CTL 100.

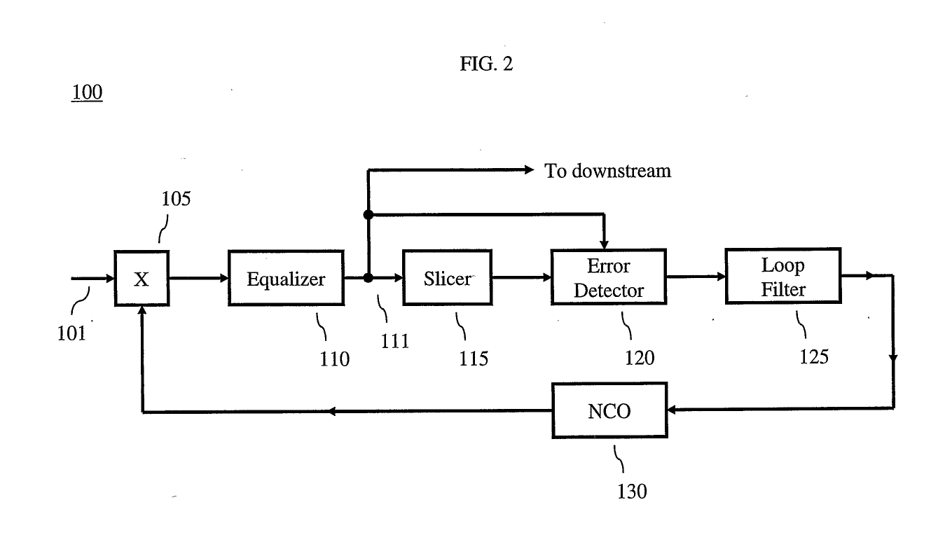

FIG. 2 is an illustrative block diagram illustrating a CTL 100 having a variable architecture in accordance with one aspect of the present invention. The CTL 100 illustratively receives a preliminarily demodulated, or frequency down-converted, and digitized signal 101. A modulated analog signal, such as an HDTV signal, can be received by an antenna and processed by an input network (not shown). The received signal may exhibit quadrature amplitude modulation (e.g., 16- or 32-QAM as known), or other forms of PAM modulation such as QPSK and VSB. QAM is a form of pulse amplitude modulated (PAM) signal in which digital information is represented by a two-dimensional grid-like symbol constellation defined by quadrature Real and Imaginary axes. A VSB signal, e.g., as proposed for use by the Grand Alliance HDTV system in the United States, is represented by a one-dimensional data symbol constellation wherein only one axis contains quantized data to be recovered by the receiver. Signals for clocking the illustrated functional blocks or a timing recovery network (as known) for deriving timing and clock signals from the received signal have been omitted.

The preliminary demodulation brings the signal closer to baseband so that the subsequent circuits do not have to operate on the intermediate frequency (IF) signal. The locally generated carrier frequency used for this purpose may not precisely match the transmitter carrier frequency, whereby phase errors result from this demodulation. These phase errors are corrected by a further demodulation process involving the CTL 100.

CTL 100 comprises a derotator 105, an equalizer 110, a slicer 115, an error detector 120, a loop filter 125, and a numerically controlled oscillator (NCO) 130. The derotator 105, as is known, removes the residual carrier frequency from the incoming signal, effectively derotating the signal back to baseband. The derotator 105 can be a complex multiplier that multiplies the incoming signal by a difference or error sinusoidal signal generated by the NCO 130.

The equalizer 110 is an adaptive equalizer that can switch between operating in blind and decision-directed modes. As known, the equalizer 110 generally removes baseband intersymbol interference (ISI) caused by transmission channel disturbances. In one embodiment, and as shown, the equalizer 110 is located within the CTL 100. That is, the equalizer 110 is disposed between the derotator 105 and the slicer 115.

The slicer 115 is illustratively implemented as a decision directed component that processes a current received symbol and makes a decision as to what the transmitted symbol is believed to be. The slicer 115 makes a decision by quantizing the received sample to a nearest constellation point. The quantized symbol is used as an estimate of the actual transmitted symbol. For each current received symbol, the slicer 115 selects, from a look-up table, the constellation point that is closest in Euclidean distance to the input symbol sample as its decision (the quantized symbol).

The error detector 120 receives an input from the equalizer 110 and the slicer 115. Generally, the error detector 120 produces an error signal that represents a phase difference between the symbol output of the equalizer 110 and the symbol output of the slicer 115. The loop filter 125 processes the error signal from the error detector 120 to provide a higher quality signal to the NCO 130. The error signal generated by the error detector 120 can include an error term and a noise term. For example, the noise term can include high frequency components. The loop filter 125 processes the error signal to generate a useful error signal while suppressing the effect of the noise.

The NCO 130 is an electronic system for synthesizing a range of frequencies from a fixed timebase. The NCO 130 can include a digital waveform generator that increments a phase counter by a per-sample increment. This phase can be looked up in a waveform table to create a sine waveform. The NCO 130, however, is phase and frequency-agile. Accordingly, the NCO 130 can be modified to produce phase-modulated or frequency-modulated outputs, or quadrature outputs.

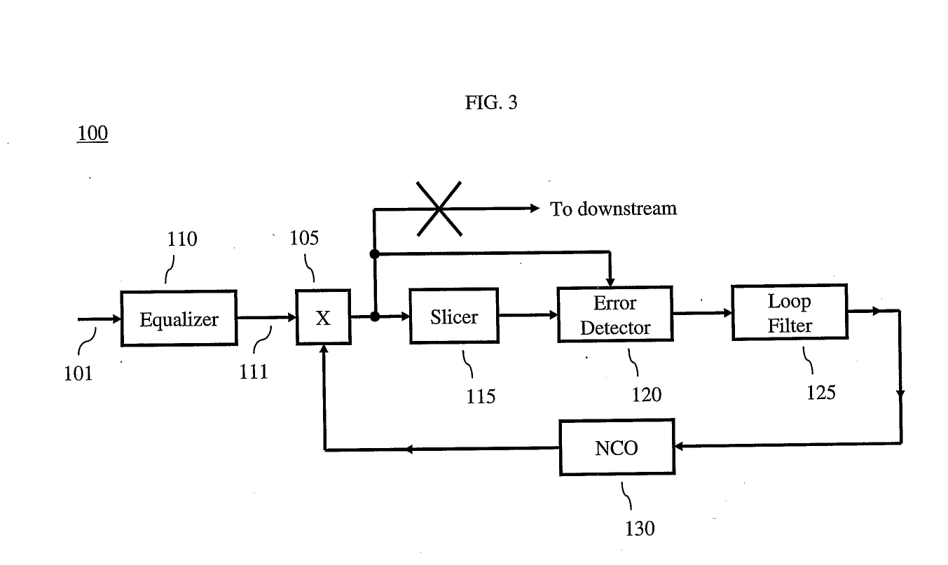

FIG. 3 is an illustrative block diagram illustrating the CTL 100 of FIG. 2, wherein the architecture has been dynamically changed in accordance with the principles of the invention. As shown in FIG. 3, equalizer 110 has been placed, in effect, external to the CTL operation. The equalizer 110 no longer operates between the derotator 105 and the slicer 115, but rather functions at the input to the CTL 100. While the equalizer 110 may still be considered a part of the CTL 100, it effectively has been relocated outside of the CTL 100.

As before, signals that have been preliminarily demodulated and digitized are provided to equalizer 110 prior to being provided to the derotator 105. By switching the architecture of the CTL 100 between those of FIGS. 2 and 3, the delay through the CTL 100 can be further reduced to provide for a wider pull in range for the CTL 100.

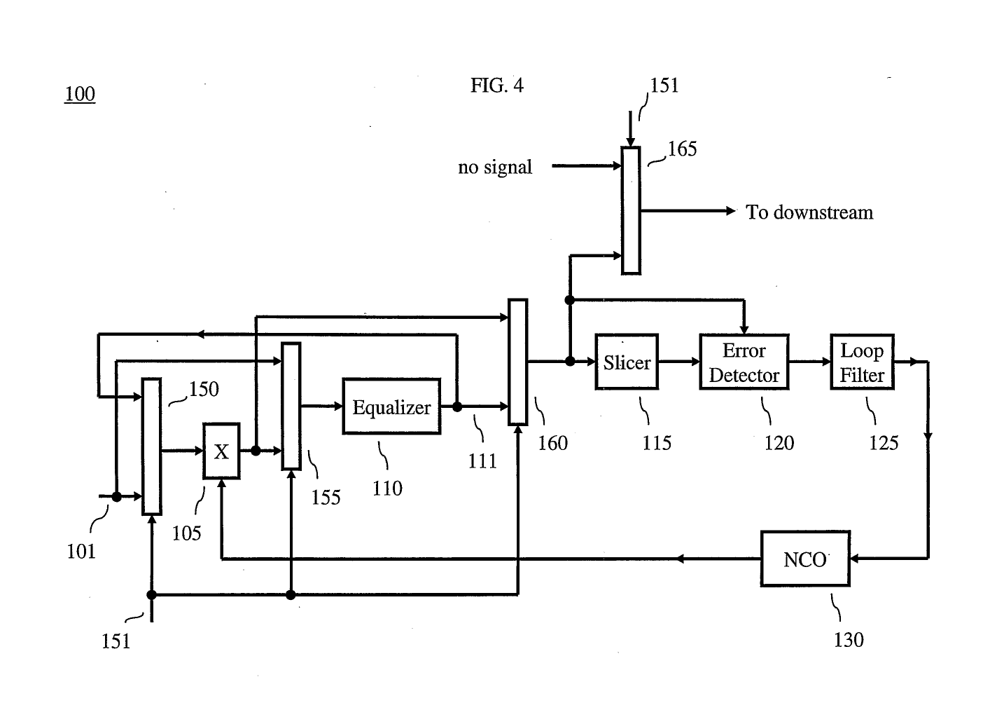

According to one embodiment, the CTL 100 can be implemented as hardware using one or more discrete components, integrated circuits, or as an application specific circuit. The location of the equalizer 110 can be effectively changed through the use of one or more multiplexers. That is, the location of the equalizer 110, with respect to the signal path, can be varied using multiplexers. This is illustrated in FIG. 4 by multiplexers 150, 155, 160 and 165. Signal 151 controls the multiplexers such that the signals can be selectively routed to the equalizer 110.

In another embodiment, the CTL 100 can be implemented within software. For example, modules of program code can be used to implement each of the components discussed with reference to FIGS. 2 and 3. In that case, the signal path can be altered through software controls such that the equalizer 110 can be selectively positioned outside of the CTL 100 and within the CTL 100 as shown.

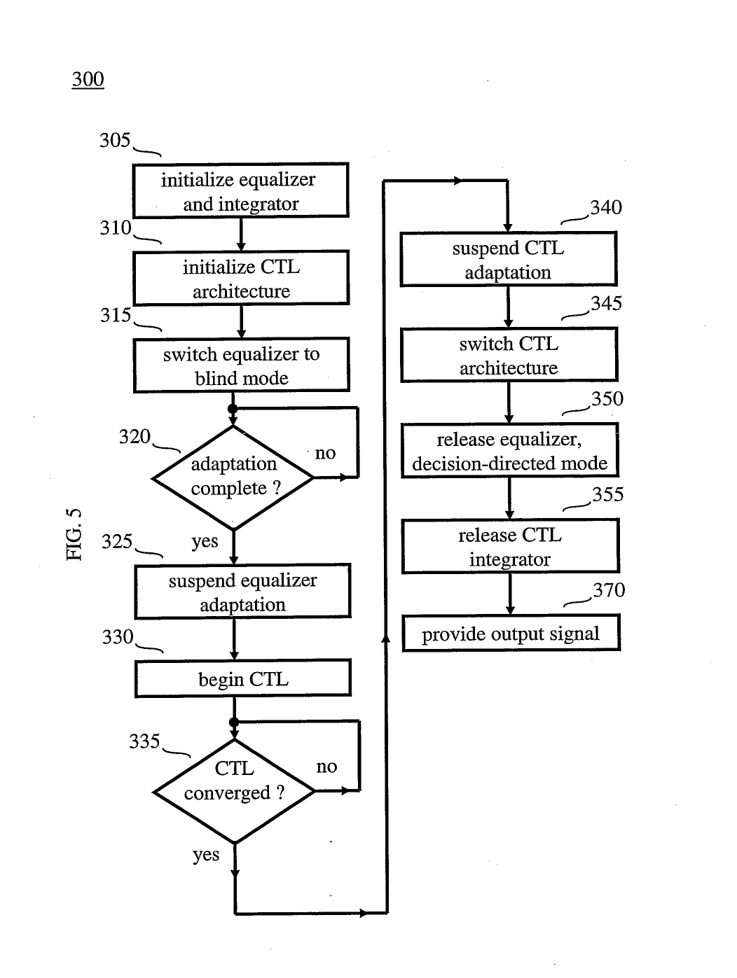

FIG. 5 is an illustrative flow chart illustrating a method 300 of performing carrier recovery and equalization using a CTL architecture having a selectively locatable equalizer. The method 300 can begin in a state where the residual carrier offset of a signal received by the CTL is unknown. Further, the signal is un-equalized. In step 305 the equalizer can be initialized with a single non-zero tap corresponding to the main path delay. Further, the CTL integrator, i.e., the NCO, can be initialized to 0, or some other a priori known optimal value.

In step 310, the architecture of the CTL can be initialized or switched to that illustrated in FIG. 3. More particularly, the location of the equalizer can be set or located to the input of the CTL, such that the output of the equalizer is fed to the input of the derotator. In this position, the equalizer can be said to be located outside of the CTL. In step 315, the equalizer can be switched to operate in blind mode. This allows the equalizer to process a spinning complex constellation. Notably, it is assumed that a symbol timing recovery loop is locked and sending valid data downstream to the CTL and other system components as may be required. At this point, the integrator can be held at “0”. As shown in FIG. 3, the signal path to downstream components is shown with an “x” indicating that signal is not yet of the quality required. As such, no signal is provided as output at this stage.

The equalizer begins functioning and adapting in blind mode such that the equalizer coefficients begin to converge. While the equalizer continues to adapt, the CTL may be inactive. That is, the CTL may not be adapting. In step 320, a decision can be made as to whether the equalizer has adapted sufficiently. The method 300 can continue to loop as shown until the equalizer has adequately adapted. Any one of a number of known techniques can be used to determine if the equalizer has sufficiently adapted. For example, over a period of time, a count can be determined of the number of equalized received symbols falling within a predefined portion of the signal space. The equalizer can be determined to have sufficiently adapted when this count exceeds a predetermined number. In step 325, once adaptation has occurred and the eye is sufficiently open to allow reasonably accurate slicing decisions on average from the slicer, further adaptation of the equalizer can be stopped.

In step 330, CTL operation can commence and begin adaptation. The integrator is no longer held at a fixed value. While the CTL functions or adapts, the equalizer can remain in a suspended state to prevent the CTL from having to adapt to a changing signal resulting from further adaptation of the equalizer. It can be assumed that the channel is quasi-static and will not change appreciably while the CTL is converging. This is likely with respect to applications of the inventive concept pertaining to cable receivers. Notably, as the equalizer is located outside of the CTL, the delay through the CTL is reduced, thereby allowing a wider pull in range.

In step 335, a determination can be made as to whether the CTL has converged to about a true residual offset value. This occurs when the constellation output of the derotator is virtually static. The method can continue to loop until such time when the CTL converges. At that point the method can proceed to step 340. In step 340, CTL adaptation is suspended. That is, the integrator value can be frozen. In step 345, the CTL architecture can be switched to that shown in FIG. 2. In other words, the architecture of the CTL can be dynamically altered such that the equalizer becomes effectively located between the derotator and the slicer. In step 350, the equalizer is released and operated in a decision-directed mode. Such can be the case as the constellation output from the derorator is relatively static as noted.

In step 355, the CTL integrator is released such that the CTL continues to adapt again. At this point, both the CTL and the equalizer are functioning and continuing to adapt and, in step 370, an output signal is provided.

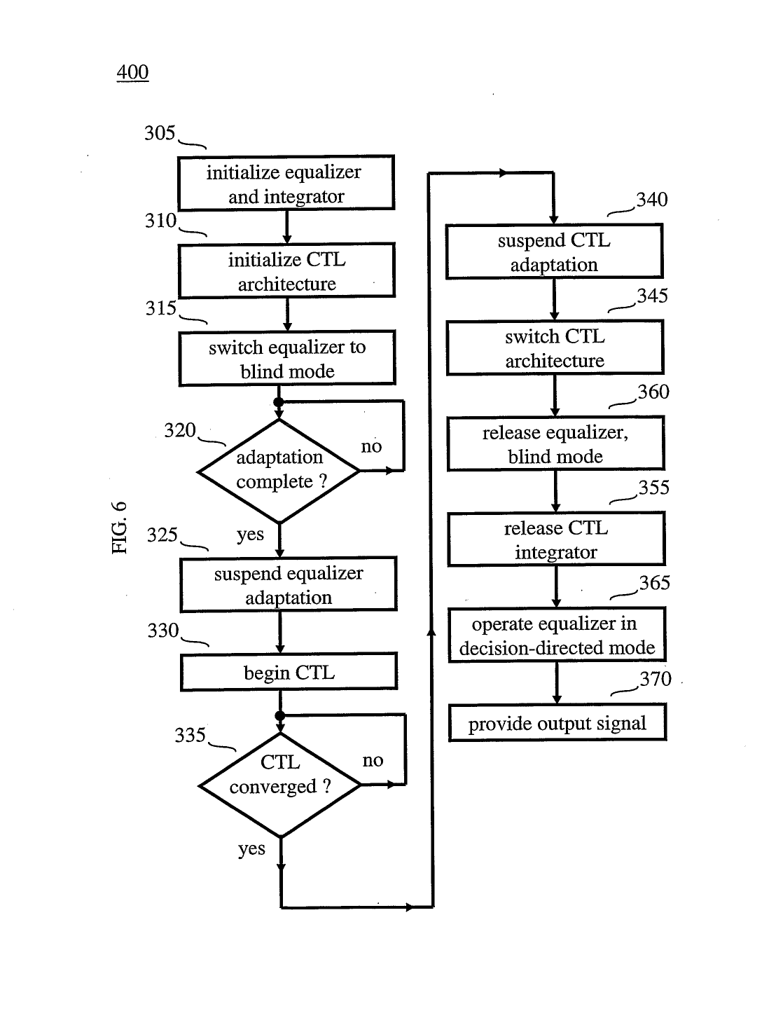

Besides the flow chart shown in FIG. 5, other variations are possible in accordance with the principles of the invention. One such variation is shown in FIG. 6. The flow chart 400 of FIG. 6 is similar to the flow chart of FIG. 5 except for the additions of steps 360 and 365. Step 360 replaces step 350 of FIG. 5. In step 360, the equalizer is switched to run in blind mode. This allows the equalizer to smooth discontinuities resulting from the switch in architecture from that of FIG. 3 to that of FIG. 2. When the equalizer is sufficiently adapted (although not shown in FIG. 6, this is similar to step 320 (described above), the equalizer is switched again to operate in decision-directed mode in step 365.

The present invention can be realized in hardware, software, or a combination of hardware and software. Aspects of the present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A receiver comprising:
a carrier tracking loop; and
an equalizer;
wherein the equalizer is selectively positionable to a location that is external to said carrier tracking loop and to a location within said carrier tracking loop according to a measure of convergence for said carrier tracking loop.

2. The receiver of claim 1, wherein the measure of convergence is met when said carrier tracking loop converges to about a true residual offset value.

3. The receiver of claim 1, wherein said equalizer operates in a blind mode when located external to said carrier tracking loop and is switched to a decision-directed mode when within said carrier tracking loop.

4. The receiver of claim 1, said carrier tracking loop further comprising:
a derotator configured to derotate received symbols;
a slicer configured to correct errors in the derotated received symbols;
an error detector configured to compare symbol output of said slicer with the derotated received symbols to determine an error signal;
a loop filter for processing the error signal; and
a numerically controlled oscillator driven by an output from said loop filter and providing a signal to said derotator for use in derotating the received symbols.

5. The receiver of claim 4, wherein said equalizer is located prior to said derotator when located external to said carrier tracking loop and between said derorator and said slicer when located within said carrier tracking loop.

6. The receiver of claim 1, wherein said equalizer is initially located external to said carrier tracking loop and functions in a blind mode.

7. The receiver of claim 6, wherein said equalizer adapts to incoming symbols and responsively suspends adaptation.

8. The receiver of claim 7, wherein after said equalizer suspends adaptation, said carrier tracking loop converges to about a true residual offset value and suspends adaptation.

9. The receiver of claim 8, wherein said equalizer is located within said carrier tracking loop and begins further adaptation functioning in a decision-directed mode.

10. The receiver of claim 9, wherein said carrier tracking loop resumes adaptation after said equalizer has been located within said carrier tracking loop.

11. The receiver of claim 10, wherein said equalizer is again switched to function in a blind mode temporarily and then switches to function in a decision directed mode prior to providing an output signal.

12. A receiver comprising:
an equalizer for receiving a received signal; and
a carrier tracking loop for tracking a carrier of the received signal;
wherein the position of the equalizer with respect to the carrier tracking loop is adjustable.

13. A method for use in a receiver, the method comprising:
positioning an equalizer to a location at an input to a carrier tracking loop;
adapting the carrier tracking loop;
when the carrier tracking loop converges to about a true residual offset value, positioning the equalizer to a location within the carrier tracking loop; and
switching the operation mode of the equalizer to a decision-directed mode.

14. The method of claim 13, further comprising the steps of
setting the equalizer to function in a blind mode; and
suspending adaptation of the equalizer in blind mode when the equalizer has sufficiently adapted;
wherein the adapting the carrier tracking loop step is performed subsequent to suspension of the equalizer adaptation.

15. The method of claim 13, wherein adaptation of the carrier tracking loop is suspended during said step of positioning the equalizer to a location within the carrier tracking loop.

16. The method of claim 15, further comprising resuming operation of the equalizer and carrier tracking loop adaptation.

17. The method of claim 13, further comprising the step of:
running the equalizer in blind mode for a period of time subsequent to positioning of the equalizer within the carrier tracking loop before switching the equalizer to function in decision-directed mode.

18. The method of claim 13, wherein the equalizer is positioned between a derotator and a slicer when positioned within the carrier tracking loop.

19. A method for use in a receiver, the method comprising:
positioning an adaptive equalizer external to a carrier tracking loop;
processing symbols with the adaptive equalizer in a blind mode when external to the carrier tracking loop;
when the carrier tracking loop converges to about a true residual offset value, positioning the adaptive equalizer within the carrier tracking loop; and
processing symbols with the adaptive equalizer using a decision-directed mode when within the carrier tracking loop.
